(19) United States
(12) Patent Application Publication
(10) Pub. No.: US 2024/0295102 A1
(43) Pub. Date: Sep. 5, 2024

(54) HYBRID FAUCET SYSTEMS

(71) Applicant: AS America, Inc., Piscataway, NJ (US)

(72) Inventors: Jesus GARCIA, Monterrey (MX); Enrique GONZALEZ-CORONA, Garcia (MX)

(73) Assignee: AS America, Inc., Piscataway, NJ (US)

(21) Appl. No.: 18/444,233

(22) Filed: Feb. 16, 2024

Related U.S. Application Data
(60) Provisional application No. 63/449,852, filed on Mar. 3, 2023.

(51) Int. Cl. E03C 1/05; F16K 11/00; F16K 31/00

(52) U.S. Cl. CPC E03C 1/057; F16K 19/006; F16K 31/002

(57) ABSTRACT

Provided herein is a hybrid faucet system comprising: a faucet body comprising a sensor configured to detect a user and an outlet; a temperature control system configured to receive hot water and cold water and form mixed water; a water volume control configured, when the hybrid faucet system is operated manually, to receive mixed water from the temperature control system and control a flow rate of water; a valve configured to receive the mixed water from the temperature control system and if the sensor detects a user and the water volume control is in a closed position, direct the mixed temperature water to the outlet of the faucet body; or if the water volume control is in an open position, direct the mixed temperature water to the water volume control to control the flow rate of the mixed water, and from the water volume control to the outlet of the faucet body.

### CROSS-REFERENCE TO RELATED APPLICATIONS

This application claims the benefit of U.S. Provisional Application No. 63/449,852, filed Mar. 3, 2023, the entire contents of which is incorporated herein by reference.

### FIELD

The present disclosure generally relates to faucet systems, and more particularly, to faucet systems having both manual and automatic controls.

### BACKGROUND

Lavatory faucet systems are provided in both manual and automatic configurations. When using a manual faucet, a user must physically touch and manipulate an on/off mechanism to operate the faucet system. For example, a user may lift a handle or knob, twist a knob, or push a button to open the faucet valve (and allow water to flow out of the faucet body outlet). An opposite force is usually required to close the faucet valve (and cease water from flowing out of the faucet body outlet). Therefore, manual faucet systems require a user to manually touch and manipulate a mechanism to operate the faucet system.

An automatic faucet system typically includes a sensor. A user can trigger the sensor to operate the automatic faucet system. For example, the sensor may be an infrared sensor, a proximity sensor, a motion sensor, or a capacitive sensor. An automatic faucet prevents the user from having to physically touch or otherwise come in contact with the faucet system.

### SUMMARY

Provided herein are hybrid faucet systems comprising a hybrid control system. Specifically, the hybrid faucet systems described herein may include both manual and automatic controls. In some embodiments, a user may choose to operate the hybrid faucet systems described herein using a manual control. In some embodiments, a user may choose to operate the hybrid faucet systems described herein using an automatic control. In some embodiments, a user may control the hybrid faucet system using both manual control mechanisms and automatic control mechanisms.

As described above, conventional manual faucet systems require a user to physically manipulate a control mechanism (e.g., knob, handle, lever) to operate the faucet. This requires the user to physically touch the control mechanism, which can introduce the user to germs, bacteria, etc. Conversely, conventional automatic faucets circumvent the need for a user to have to physically touch a control mechanism (or any portion of the faucet system). However, automatic faucets generally do not allow a user to control the temperature or volume of the water flow. Automatically-controlled faucets also cannot be operated in the event of power loss.

Accordingly, the hybrid faucet systems provided herein allow a user to both manually and automatically control features of the faucet system. The faucet system may be turned on and off using either a manual or an automatic control. The temperature can be controlled using a manual control mechanism (utilizing either a mechanical valve or a thermostatic valve). The water volume or flow rate may be controlled using a manual control mechanism. The temperature and water volume can be set/controlled manually, and then a user may operate the faucet system (i.e., turn the faucet system on or off) using an automatic control. In some embodiments, the faucet system may be controlled entirely manually. The faucet system may comprise a first handle that controls the temperature, and a second handle that controls the water volume.

In some embodiments, provided is a hybrid faucet system comprising: a faucet body comprising a sensor configured to detect a user and an outlet; a temperature control system configured to receive hot water from a hot water supply and cold water from a cold water supply and mix the hot water and cold water to form mixed water; a water volume control configured, when the hybrid faucet system is operated manually, to receive mixed water from the temperature control system and control a flow rate of water that is dispensed from the outlet of the faucet body; a valve configured to receive the mixed water from the temperature control system and if the sensor detects a user and the water volume control is in a closed position, direct the mixed temperature water to the outlet of the faucet body; or if the water volume control is in an open position, direct the mixed temperature water to the water volume control to control the flow rate of the mixed water, and from the water volume control to the outlet of the faucet body.

In some embodiments of the hybrid faucet system, the hybrid faucet system comprises a solenoid valve, wherein when the solenoid valve is in an open position, the valve is configured to direct the mixed water to the outlet of the faucet body, and when the solenoid valve is in a closed position, the valve is configured to direct the mixed temperature water to the water volume control to control the flow rate of the mixed water, and from the water volume control to the outlet of the faucet body.

In some embodiments of the hybrid faucet system, the hybrid faucet system comprises a microcontroller coupled to the sensor configured to send, when the sensor detects a user's presence a signal to the solenoid valve opening the solenoid valve such that the mixed water is directed to the outlet of the faucet body.

In some embodiments of the hybrid faucet system, the solenoid valve is configured to switch from an open position to a closed position after a predetermined amount of time has passed.

In some embodiments of the hybrid faucet system, the solenoid valve is configured to switch from an open position to a closed position when the solenoid valve receives a signal from the microcontroller indicating a user's absence.

In some embodiments of the hybrid faucet system, the hybrid faucet system comprises a flow sensor positioned between the valve and the faucet body and configured to, when the water volume control is in an open position and the hybrid faucet system is operated manually, override any signal received by the solenoid valve from the microcontroller such that the hybrid faucet system is operated manually by the water volume control and is not operated automatically by the sensor.

In some embodiments of the hybrid faucet system, the temperature control system is configured to be operated manually by a user to control an amount of hot water received from the hot water supply relative to the amount of cold water received from the cold water supply.

In some embodiments of the hybrid faucet system, the temperature control system comprises a stop mechanism wherein when a cartridge of the temperature control system is in a fully hot position, the stop mechanism prevents the temperature control system from moving any further in a first direction, and when the cartridge of the temperature control system is in a fully cold position, the stop mechanism prevents the temperature control system from moving any further in a second direction.

In some embodiments of the hybrid faucet system, the temperature control system comprises a mechanical valve.

In some embodiments of the hybrid faucet system, the temperature control system comprises a thermostatic valve.

In some embodiments of the hybrid faucet system, the sensor is an infrared sensor.

In some embodiments of the hybrid faucet system, the sensor is a proximity sensor.

In some embodiments, a method of operating a hybrid faucet system is provided, the method comprising: manually manipulating a temperature control system to control an amount of hot water flowing from the temperature control system relative to an amount of cold water flowing from the temperature control system; and manually operating a water volume control to control a flow rate of mixed temperature water received from the temperature control system and direct the mixed temperature water to an outlet of a faucet body of the hybrid faucet system; or triggering a sensor of a faucet body to signal to a solenoid valve to assume an open position to receive the mixed temperature water received from the temperature control system and direct the mixed temperature water to an outlet of a faucet body of the hybrid faucet system; and overriding any signal received from the sensor of the faucet body when the water volume control is being manually operated.

In some embodiments, any one or more of the features, characteristics, or elements discussed above with respect to any of the embodiments may be incorporated into any of the other embodiments mentioned above or described elsewhere herein.

### BRIEF DESCRIPTION OF THE FIGURES

FIG. 1 shows a perspective view of a hybrid faucet system comprising a mechanical valve in the temperature control system, according to some embodiments;

FIG. 2 shows an exploded view of a hybrid faucet system comprising a mechanical valve in the temperature control system, according to some embodiments;

FIG. 3 shows a portion of a hybrid faucet system comprising a T-valve, solenoid valve, and flow sensor, according to some embodiments;

FIG. 4A shows a perspective view of a temperature control system comprising a manual temperature control and a mechanical valve, according to some embodiments;

FIG. 4B shows a cross-sectional view of a temperature control system comprising a manual temperature control and a mechanical valve, according to some embodiments;

FIG. 5 shows a stop mechanism of a mechanical valve, according to some embodiments;

FIG. 6 shows a perspective view of a hybrid faucet system comprising a thermostatic valve in the temperature control system, according to some embodiments;

FIG. 7 shows an exploded view of a hybrid faucet system comprising a thermostatic valve in the temperature control system, according to some embodiments;

FIG. 8A shows a shows a perspective view of a temperature control system comprising a manual temperature control and a thermostatic valve, according to some embodiments;

FIG. 8B shows a cross-sectional view of a temperature control system comprising a manual temperature control and a thermostatic valve, according to some embodiments; and

FIG. 9 shows a stop mechanism of a manual temperature control comprising a thermostatic cartridge, according to some embodiments.

### DETAILED DESCRIPTION

Described herein are hybrid faucet systems that can be operated using both manual and automatic control mechanisms. For example, the temperature and/or water volume may be determined and set using a manual control. The manual temperature control may be separate from the manual water volume control. The faucet may be operated (i.e., turned on and off) using an automatic control. In some embodiments, the faucet may be operated (i.e., turned on and off) using a manual control. In some embodiments, the manual control that turns the faucet on and off is the same control as the manual water volume control.

Unlike a conventional dual-control manual faucet, which has a control for the hot water and a control for the cold water, and each control also individually controls the water volume of the hot water and the water volume of the cold water respectively, the hybrid faucet systems described herein include a control for temperature (which controls the ratio of hot and cold water) and a separate control for water volume/flow rate. Specifically, a cartridge or valve (e.g., mechanical valve, thermostatic valve) coupled to the manual temperature control/handle receives hot water from a hot water supply and cold water from a cold water supply and mixes the hot and cold water to form mixed temperature water (or mixed water). The mixed water then flows to a T-valve, which directs the water in one of two directions based on whether the faucet system is being controlled manually or automatically. If being operated manually, the T-valve directs the water to the manual control (also the water volume control). If being operated automatically, the T-valve directs the water to a solenoid valve. The solenoid valve can turn the water (i.e., faucet system) on and off based on signals from a microcontroller in a sensor capsule located within the faucet body. (The sensor capsule within the faucet body comprises a sensor that detects a user and sends a signal to the solenoid valve when the user's presence is detected by the sensor.) A flow sensor may also be included. The flow sensor may function to override the signal from the microcontroller of the sensor when the faucet is manually activated to keep the solenoid valve turned off until the manual water volume control is closed.

Operating the hybrid faucet system may be convenient for handwashing or brushing teeth, for example. In these cases, for example, a user's hand near a sensor (e.g., presence sensor) will turn the water of the hybrid faucet system on, and removal of the user's hand will cause the water of the hybrid faucet system to turn off. This operation can generate water savings.

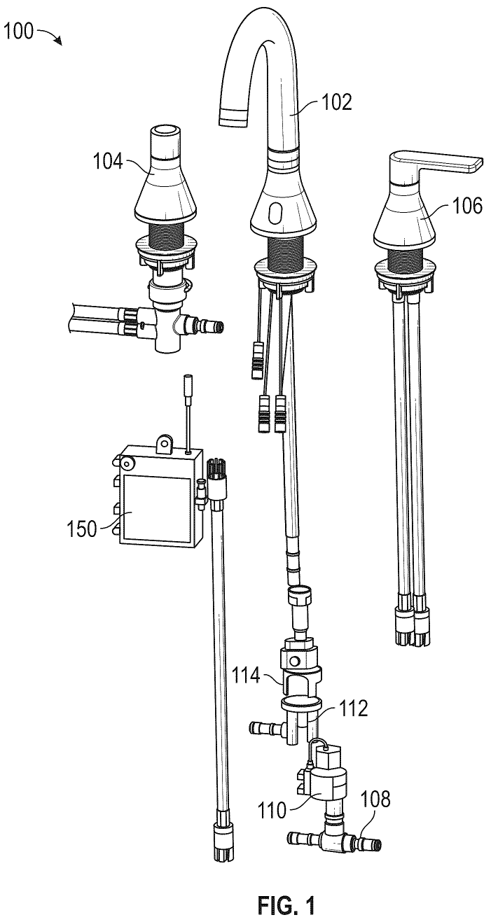

FIG. 1 shows a perspective view of a hybrid faucet system 100 comprising a mechanical valve in the temperature control system, according to some embodiments. Hybrid faucet system 100 comprises faucet body 102, manual temperature control 104, manual water volume control 106, T-valve 108, solenoid valve 110, connector 112, and flow sensor 114.

The hybrid faucet system 100 of FIG. 1 also includes a battery box 150. The battery box 150 provides power to the sensor and/or solenoid valve of the hybrid faucet system 100. Battery box 150 can provide power to these component parts of the hybrid faucet system 100 using AC power, DC power, or a combination of AC and DC power. In some embodiments, the power source may include one or more batteries (or a battery pack). In some embodiments, the power source may include connection to an electric outlet. In some embodiments, the power source 150, controller (e.g., microcontroller), sensor configured to detect a user, flow sensor 114, and solenoid valve 110 are in electronic communication. The electronic communication between the controller, sensors, and solenoid valve may be wired or may be wireless.

As described herein, the hybrid faucet system 100 may be operated manually or automatically. Thus, in the event of power loss, the hybrid faucet system 100 can still be easily operated manually using the manual controls.

Hybrid faucet system 100 may be installed on a surface or deck. The surface or deck may be, for example, a vanity surface or other countertop surface. In some embodiments, hybrid faucet system 100 may be installed on deck in a bathroom, a kitchen, a laundry room, or the like.

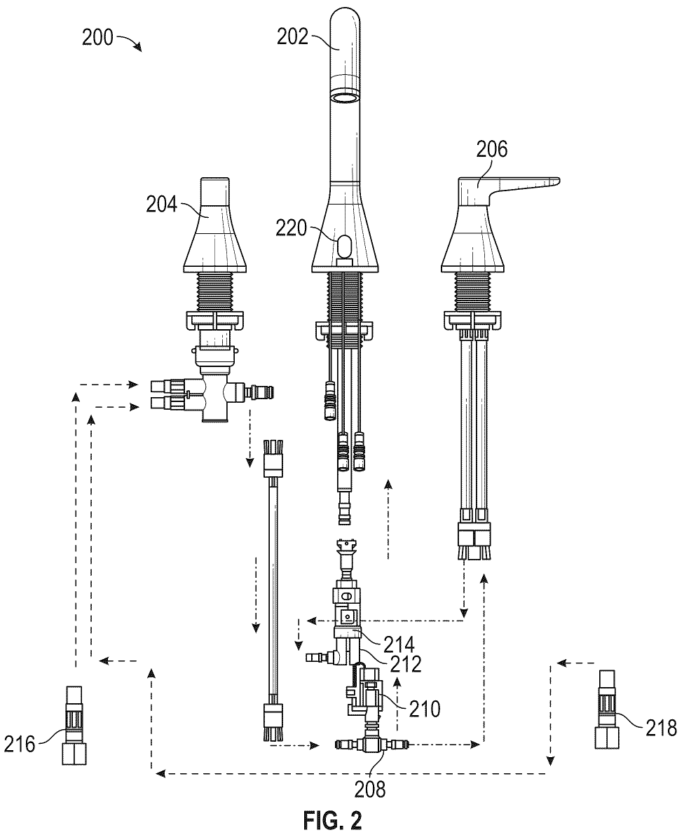

FIG. 2 shows an exploded view of a hybrid faucet system 200 comprising a mechanical valve in the temperature control system, according to some embodiments. As shown, hybrid faucet system 200 comprises a faucet body 202, a manual temperature control 204, a manual water volume control 206, a T-valve 208, a solenoid valve 210, a connector 212, a flow sensor 214, a hot water inlet 216, and a cold water inlet 218.

Faucet body 202 comprises an outlet through which water exits the faucet system and is dispensed (e.g., into a basin). Faucet body 202 also includes a sensor 220 which allows a user to control the faucet system automatically. In some embodiments, the sensor 220 may comprise an infrared sensor configured to detect a user proximate to the infrared sensor, a proximity sensor configured to detect an object within a certain distance from the sensor (e.g., a hand of a user), a motion sensor configured to detect motion (e.g., hand motion from a user), or a capacitive sensor located within the faucet body 202. Sensor 220 may be located at a base portion of the faucet body 202, or proximate to a deck top to which the faucet body is mounted. In some embodiments, the sensor 220 is housed within the faucet body 202 behind a sensor window. In some embodiments, the faucet body 202 comprises a sensor capsule comprising the sensor 220 and a microcontroller configured to receive signals from the sensor 220 and send the signals to the solenoid valve 210.

A user may manually manipulate (e.g., lift, turn, rotate, twist) the manual temperature control 204 to control the amount of hot water relative to the amount of cold water flowing from the mechanical cartridge in the temperature control system. When the user manipulates the manual temperature control 204, it causes the manual cartridge to turn or rotate. As the manual cartridge turns or rotates, it changes the amount of hot water relative to the amount of cold water that is sent to the mixing chamber of the cartridge. Hot water flows to the cartridge from hot water supply 216. Cold water flows to the cartridge from cold water supply 218.

The mechanical valve of the temperature control system receives hot and/or cold water and mixes them in a mixing chamber of the cartridge to form mixed temperature water (mixed water). From the mixing chamber, the mixed water flows to T-valve 208, from which the mixed water can be directed to either the manual water volume control 206 (if the hybrid faucet system 200 is being operated manually) or to the solenoid valve 210 (if the hybrid faucet system 200 is being operated automatically). Specifically, if the hybrid faucet system 200 is being controlled automatically (via sensor 220), a microcontroller associated with the sensor 220 will send a signal to solenoid valve 210 to open and allow water to flow through the solenoid valve 210 from T-valve 208 and to the faucet body 202 (and outlet thereof). If no signal is received from the microcontroller of the sensor 220 to open the solenoid valve 210, then the T-valve 208 directs the mixed water to the manual water volume control 206.

In some embodiments, if the sensor 220 signals to the solenoid valve 210 to open, the solenoid valve 210 will switch to a closed position after a predetermined amount of time. For example, the solenoid valve 210 may automatically close after 5-30, 5-20, or 5-10 seconds. In some embodiments, the solenoid valve 210 may automatically switch to a closed position after a time period that is less than 30, 25, 20, 15, or 10 seconds. In some embodiments, the solenoid valve 210 may automatically switch to an open position after a time period of greater than or equal to 5, 10, 15, 20, or 25 seconds. When the solenoid valve 210 assumes a closed position, it prevents water from flowing to the faucet body 202 and out of the outlet of the faucet body 202.

In some embodiments, the solenoid valve 210 assumes a closed position when a signal is received from the microcontroller coupled to the sensor 220 indicating a user's absence. In some embodiments, the solenoid valve 210 will remain in an open position once it receives a signal from the microcontroller coupled to the sensor 220 indicating a user's presence, and will only assume a closed position when a signal is received indicating a user's absence. In some embodiments, the solenoid valve 210 will only remain in an open position so long as it receives a constant signal indicating a user's presence, and as soon as the signal indicating a user's presence is no longer received, the solenoid valve 210 will assume a closed position.

In some embodiments, the microcontroller is configured to communicate wirelessly with the solenoid valve 210. In some embodiments, the microcontroller is configured to communicate with the solenoid valve 210 using a wired connection. In some embodiments, the power source, controller (e.g., microcontroller), sensor 220, flow sensor 214, and solenoid valve 210 are in electronic communication. The electronic communication between the controller, sensors, and solenoid valve may be wired or may be wireless.

The manual water volume control 206 controls a flow rate of water that flows through the manual water volume control 206, to the faucet body 202, and out of the outlet of the faucet body 202. If a user wants a heavy flow of water from the faucet body 202, the user can open the water volume control 206 to a greater extent than if the user wants a lighter flow of water from the faucet body 202. The manual water volume control 206 does not control the water temperature (i.e., the amount of water received from a hot water supply relative to the amount of water received from a cold water supply). The manual water volume control 206 only controls the rate at which water from the manual temperature control 204 flows through the manual water volume control 206, to the faucet body 202, and is dispensed from the outlet of the faucet body 202.

A connector 212 is configured to receive mixed water from solenoid valve 210 (if the hybrid faucet system 200 is being operated automatically) or from manual water volume control 206 (if the hybrid water faucet system 200 is being operated manually). From the connector 112, the mixed water is then directed to a flow sensor 214 (if operating in manually), and to the faucet body 202, from which it is dispensed from an outlet of the faucet body 202. If the hybrid faucet system 200 is operating automatically, the mixed water bypasses the flow sensor 214. The flow sensor 214 is configured to communicate the presence of water flow to the controller (e.g., microcontroller). The controller is then configured to disable automatic mode (e.g., not allow the opening of the solenoid valve 210, to turn off the sensor 220, or to not receive signals from the sensor 220) when operating manually. In this way, manual mode is configured to override automatic mode, and why the automatic/solenoid flow path and manual flow path are parallel.

In some embodiments, the hybrid faucet system 200 may not include a flow sensor 214. For example, an electronic switch may instead be included. In such an embodiment, the electronic switch can be associated with manual water volume control 206 (e.g., a switch within the handle of manual water volume control 206). The electronic switch may be in electronic communication with the controller, such that the controller is configured to disable automatic mode when the switch is activated.

In some embodiments, the manual water volume control 206 and the manual temperature control 204 are operated independently.

In some embodiments, flow sensor 214 is configured to override automatic operation of the hybrid faucet system 200 when the hybrid faucet system is operated manually. For example, if a user chooses to operate the hybrid faucet system 200 manually, there is a risk that the user will inadvertently trigger the sensor 220 when the user places his or her hands in the path of water dispensing from the faucet body outlet. This will cause the user to inadvertently shut off the water flow via the sensor 220 when he or she is trying to utilize the manually-controlled water flow. Therefore, flow sensor 214 is configured to detect when the manual water volume handle 206 is open (i.e., when a user manually turns the hybrid faucet system 200 on) and override any signals received from the microcontroller coupled to the sensor 220 when the manual water volume handle 206 is open. When the hybrid faucet system 200 is operated automatically, the mixed water may bypass the flow sensor 214.

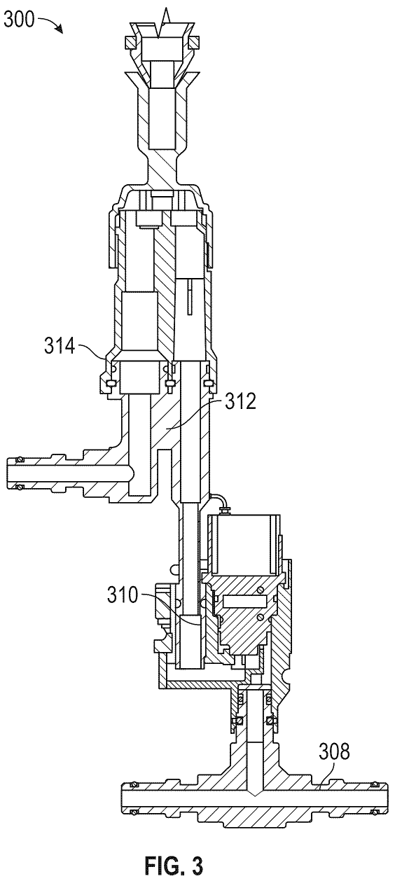

FIG. 3 shows a portion 300 of a hybrid faucet system comprising a T-valve 308, solenoid valve 310, connector 312, and flow sensor 314, according to some embodiments. This portion 300 of a hybrid faucet system shows both automatic and manual flow paths. Note that the flow sensor 304 is only located in the manual flow path.

As described above, the T-valve 308 receives water from a mixing chamber. The water received is directed, by the T-valve 308, to either a manual water volume control (if the hybrid faucet system is being operated manually), or to solenoid valve 310 (if the hybrid faucet system is being operated automatically). The portion 300 of the hybrid faucet system shown in FIG. 3 specifically shows the components through which water would travel when the hybrid faucet system is being operated automatically. Specifically, when solenoid valve 310 receives a signal from the microcontroller coupled to a sensor located in the faucet body of the hybrid faucet system, it will open to allow water to flow through. Therefore, water will flow from T-valve 308, through solenoid valve 310, through connector 312, and up to the faucet of the hybrid faucet system when the hybrid faucet system is being operated automatically.

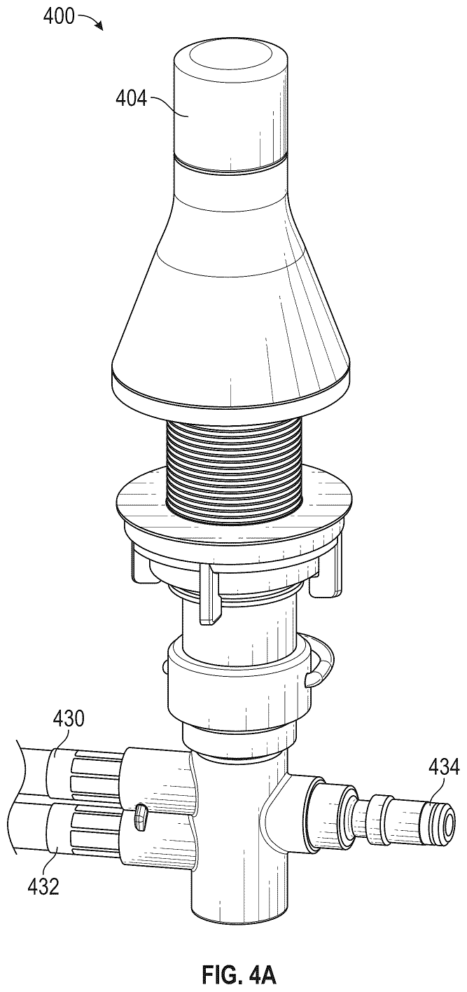

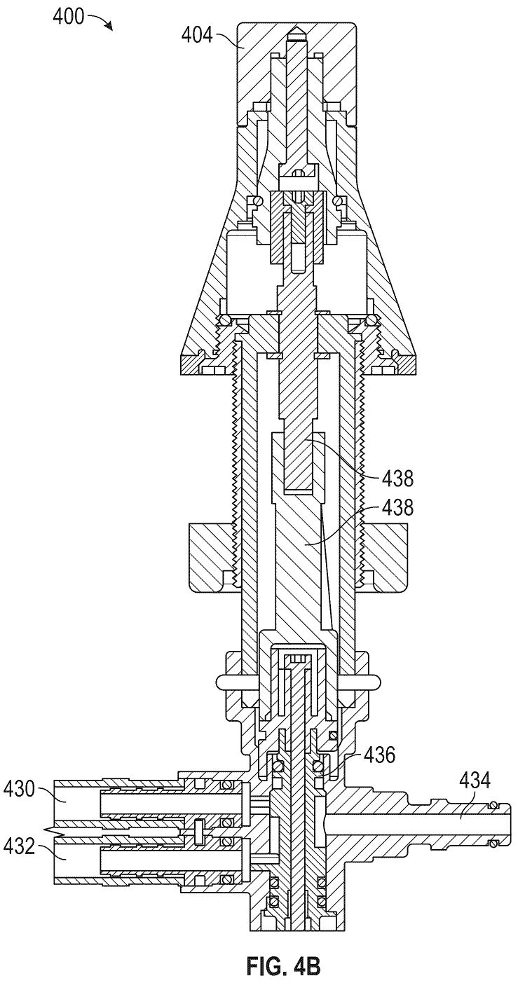

FIG. 4A shows a perspective view of a temperature control system 400 comprising a manual temperature control 404 and a mechanical valve, according to some embodiments. The temperature control system 400 also comprises a hot water inlet 430, a cold water inlet 432, and a mixed water outlet 434. The manual temperature control 404 is configured to be manipulated by a user (e.g., by turning or rotating). When the manual temperature control is manipulated, it controls a mechanical valve that determines the amount of hot water relative to the amount of cold water. Within the valve, the hot water and cold water mix to form mixed water, which then exits the valve via mixed water outlet 434. The temperature control system 400 is configured such that, when mounted, the manual temperature control 404 is positioned above the deck and the mechanical valve, hot water inlet 430, cold water inlet 432, and mixed water outlet 434 are all located below the deck.

FIG. 4B shows a cross-sectional view of a temperature control system 400 comprising a manual temperature control 404 and a mechanical valve 436, according to some embodiments. As shown, the manual temperature control 404 is mechanically connected to mechanical valve 436 with one or more connectors 438. As a user turns or rotates manual temperature control 404, the one or more connectors 438 also turn, causing the mechanical valve 436 to turn. Turning of the mechanical valve 436 dictates the amount of hot water intake relative to the amount of cold water intake into the mechanical valve 436. As described above, the hot water and cold water enter the mechanical valve 436 and mix within a mixing chamber of the valve to form mixed water. The mixed water then exits the mechanical valve 436 via mixed water outlet 434.

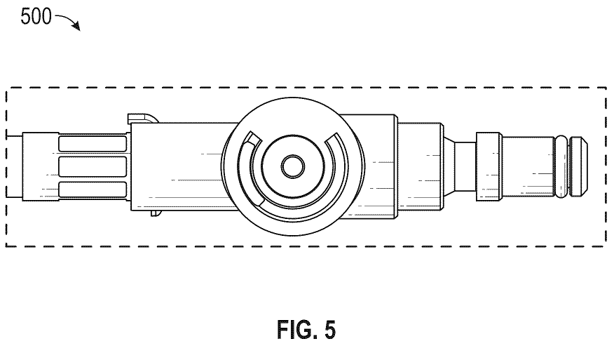

FIG. 5 shows a stop mechanism 500 of a mechanical valve, according to some embodiments. In some embodiments, the manual temperature control may comprise a stop mechanism 500, such as that depicted in FIG. 5. The stop mechanism 500 prevents the manual temperature control from being turned a full 360° or greater. A stop mechanism 500 therefore allows a user to know when they have the manual temperature control in a fully “hot” position (i.e., when the handle is fully turned in a first direction) and in a fully “cold” position (i.e., when the handle is fully turned in a second direction).

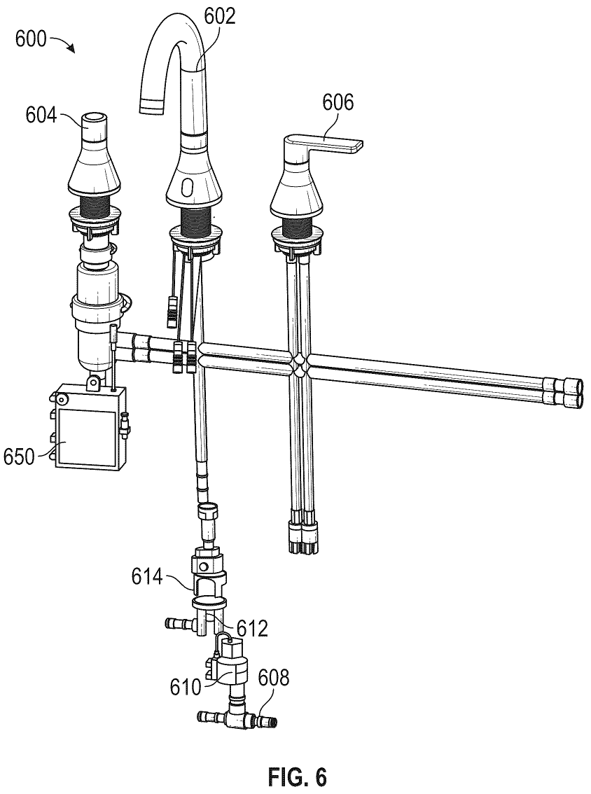

FIG. 6 shows a perspective view of a hybrid faucet system 600 comprising a thermostatic valve, according to some embodiments. Hybrid faucet system 600 comprises faucet body 602, manual temperature control 604, manual water volume control 606, T-valve 608, solenoid valve 610, connector 612, and flow sensor 614.

The hybrid faucet system 600 of FIG. 6 also includes a battery box 650. The battery box 650 provides power to the sensor and/or solenoid valve of the hybrid faucet system 100. Battery box 650 can provide power to these component parts of the hybrid faucet system 600 using AC power, DC power, or a combination of AC and DC power. In some embodiments, the power source may include one or more batteries. In some embodiments, the power source may include connection to an electric outlet.

As described herein, the hybrid faucet system 600 may be operated manually or automatically. Thus, in the event of power loss, the hybrid faucet system 600 can still be easily operated manually using the manual controls.

Hybrid faucet system 600 may be installed on a surface or deck. The surface or deck may be, for example, a vanity surface or other countertop surface. In some embodiments, hybrid faucet system 600 may be installed on deck in a bathroom, a kitchen, a laundry room, or the like.

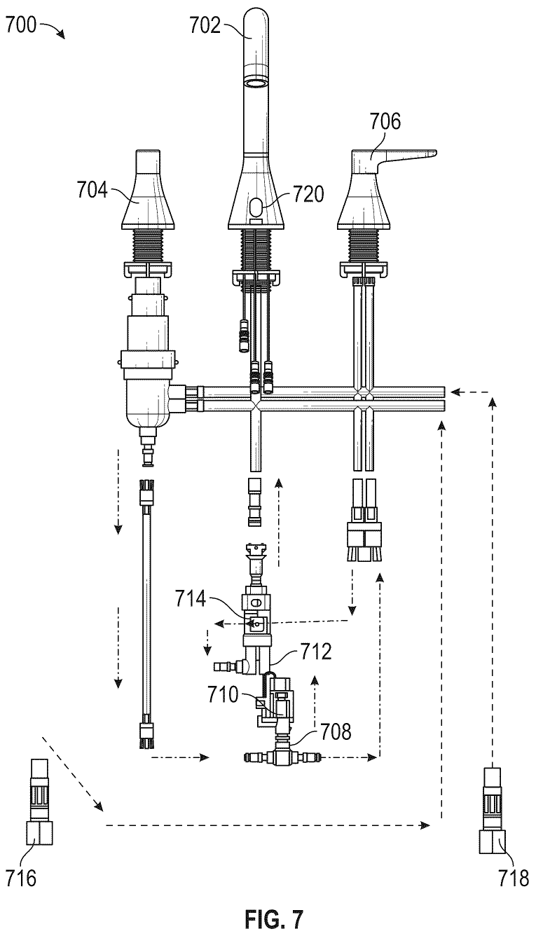

FIG. 7 shows an exploded view of a hybrid faucet system 700 comprising a thermostatic valve, according to some embodiments. As shown, hybrid faucet system 700 comprises a faucet body 702, sensor 720, a manual temperature control 704, a manual water volume control 706, a T-valve 708, a solenoid valve 710, a connector 712, a flow sensor 714, a hot water inlet 716, and a cold water inlet 718.

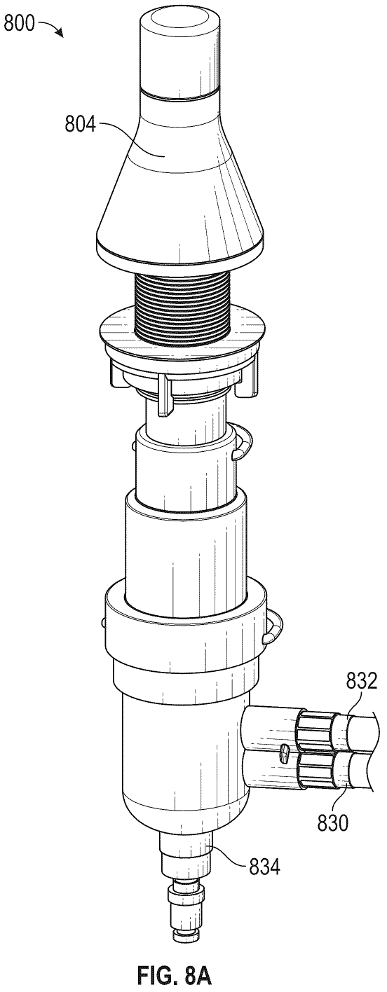

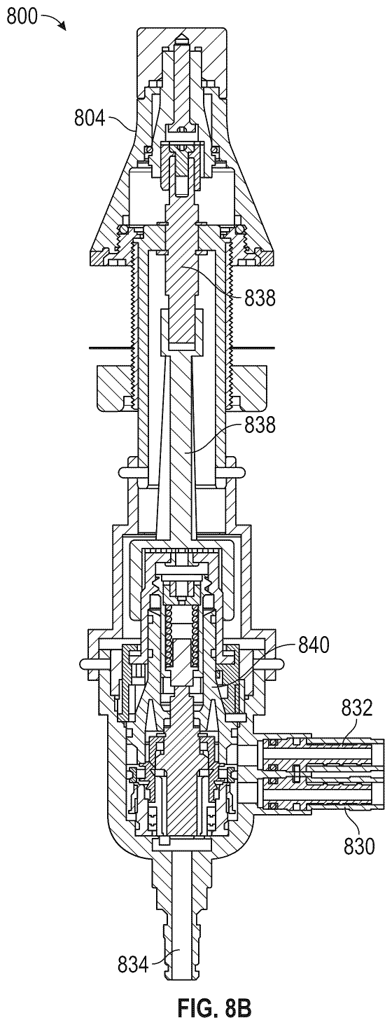

The hybrid faucet system 700 of FIG. 7 includes many of the same features as the system shown and described with respect to FIG. 2. The main difference between the hybrid faucet system 700 of FIG. 7 and that of FIG. 2 is the valve in the temperature control system controlled by the manual temperature control 704. As described above, hybrid faucet system 200 includes a mechanical valve controlled by the manual temperature control. Conversely, hybrid faucet system 700 includes a thermostatic valve controlled by the manual temperature control 704, which is described in more detail with respect to FIGS. 8A and 8B.

FIG. 8A shows a shows a perspective view of a temperature control system 800 comprising a manual temperature control 804 and a thermostatic valve, according to some embodiments. The temperature control system 800 also includes a cold water inlet 832, a hot water inlet 830, and a mixed temperature water outlet 834. The manual temperature control 804 is configured to be manipulated (e.g., twisted, turned, rotated) by a user. When the manual temperature control 804 is manipulated by the user, it operates the thermostatic valve to control how much hot water flows from the temperature control system 800 relative to the amount of cold water that flows from temperature control system 800. As explained above with respect to temperature control system 400 of FIGS. 4A and 4B, hot water enters the cartridge (e.g., thermostatic valve) from a hot water supply at the hot water inlet 830 and cold water enters the cartridge (e.g., thermostatic valve) from a cold water supply at the cold water inlet 832. The hot water and cold water mix in a mixing chamber of the thermostatic valve to form mixed temperature water. The mixed temperature water exits the temperature control system 400 at the mixed temperature water outlet 834. The temperature control system 800 is configured such that, when mounted, the manual temperature control 804 is positioned above the deck and the thermostatic valve, hot water inlet 830, cold water inlet 832, and mixed water outlet 834 are all located below the deck.

FIG. 8B shows a cross-sectional view of a temperature control system 800 comprising a manual temperature control 804 and a thermostatic valve 840, according to some embodiments. The temperature control system 800 also includes one or more connectors 838 to physically connect the manual temperature control 804 with the thermostatic cartridge 840. When the manual temperature control 804 is manipulated by a user (e.g., rotated, turned), one or more connectors 838 are also manipulated. This motion causes the thermostatic valve 840 to rotate, controlling the amount of cold water relative to the amount of hot water that flows from thermostatic valve 840. As described above, the hot water enters the thermostatic valve 840 at a hot water inlet 830 and cold water enters the thermostatic valve 840 at a cold water inlet 832. The hot and cold water mix in a mixing chamber of the thermostatic valve 840 to produce mixed temperature water. The mixed temperature water exits the temperature control system 800 at mixed temperature water outlet 834.

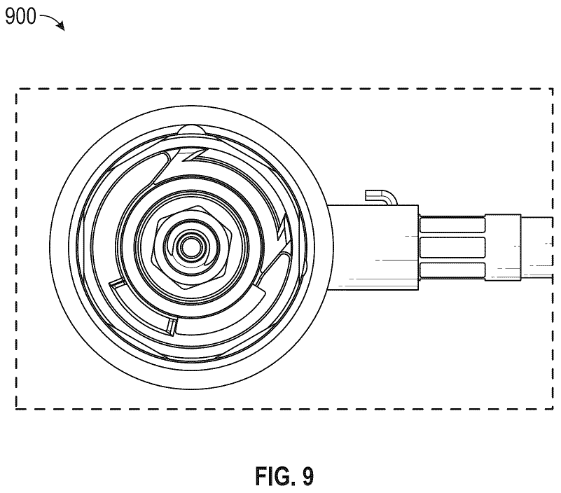

FIG. 9 shows a stop mechanism 900 of a manual temperature control comprising a thermostatic cartridge, according to some embodiments. The stop mechanism 900 prevents the manual temperature control from rotating a full 360° (or more). Instead, the stop mechanism 900 “stops” the manual temperature control in a first direction (e.g., clockwise) when the thermostatic valve is in a fully hot position, and “stops” the manual temperature control in a second direction (e.g., counterclockwise) when the thermostatic cartridge is in a fully cold position. A fully hot position is when all, or a large majority, of the water entering the thermostatic valve is hot water for the hot water inlet/hot water supply. A fully cold position is when all, or a large majority, of the water entering the thermostatic valve is cold water from the cold water inlet/cold water supply.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A hybrid faucet system comprising:
a faucet body comprising a sensor configured to detect a user and an outlet;
a temperature control system configured to receive hot water from a hot water supply and cold water from a cold water supply and mix the hot water and cold water to form mixed water;
a water volume control configured, when the hybrid faucet system is operated manually, to receive mixed water from the temperature control system and control a flow rate of water that is dispensed from the outlet of the faucet body;
a valve configured to receive the mixed water from the temperature control system and
if the sensor detects a user and the water volume control is in a closed position, direct the mixed temperature water to the outlet of the faucet body; or
if the water volume control is in an open position, direct the mixed temperature water to the water volume control to control the flow rate of the mixed water, and from the water volume control to the outlet of the faucet body.

2. The hybrid faucet system of claim 1, comprising a solenoid valve, wherein when the solenoid valve is in an open position, the valve is configured to direct the mixed water to the outlet of the faucet body, and when the solenoid valve is in a closed position, the valve is configured to direct the mixed temperature water to the water volume control to control the flow rate of the mixed water, and from the water volume control to the outlet of the faucet body.

3. The hybrid faucet system of claim 2, comprising a microcontroller coupled to the sensor configured to send, when the sensor detects a user's presence a signal to the solenoid valve opening the solenoid valve such that the mixed water is directed to the outlet of the faucet body.

4. The hybrid faucet system of claim 2, wherein the solenoid valve is configured to switch from an open position to a closed position after a predetermined amount of time has passed.

5. The hybrid faucet system of claim 2, wherein the solenoid valve is configured to switch from an open position to a closed position when the solenoid valve receives a signal from the microcontroller indicating a user's absence.

6. The hybrid faucet system of claim 2, comprising a flow sensor positioned between the valve and the faucet body and configured to, when the water volume control is in an open position and the hybrid faucet system is operated manually, override any signal received by the solenoid valve from the microcontroller such that the hybrid faucet system is operated manually by the water volume control and is not operated automatically by the sensor.

7. The hybrid faucet system of claim 2, wherein the temperature control system is configured to be operated manually by a user to control an amount of hot water received from the hot water supply relative to the amount of cold water received from the cold water supply.

8. The hybrid faucet system of claim 2, wherein the temperature control system comprises a stop mechanism wherein when a cartridge of the temperature control system is in a fully hot position, the stop mechanism prevents the temperature control system from moving any further in a first direction, and when the cartridge of the temperature control system is in a fully cold position, the stop mechanism prevents the temperature control system from moving any further in a second direction.

9. The hybrid faucet system of claim 1, wherein the temperature control system comprises a mechanical valve.

10. The hybrid faucet system of claim 1, wherein the temperature control system comprises a thermostatic valve.

11. The hybrid faucet system of claim 1, wherein the sensor is an infrared sensor.

12. The hybrid faucet system of claim 1, wherein the sensor is a proximity sensor.

13. A method of operating a hybrid faucet system, comprising:
manually manipulating a temperature control system to control an amount of hot water flowing from the temperature control system relative to an amount of cold water flowing from the temperature control system; and
manually operating a water volume control to control a flow rate of mixed temperature water received from the temperature control system and direct the mixed temperature water to an outlet of a faucet body of the hybrid faucet system; or
triggering a sensor of a faucet body to signal to a solenoid valve to assume an open position to receive the mixed temperature water received from the temperature control system and direct the mixed temperature water to an outlet of a faucet body of the hybrid faucet system.

14. The method of claim 13, further comprising overriding any signal received from the sensor of the faucet body when the water volume control is being manually operated.
